(19) United States
(12) Patent Application Publication
(10) Pub. No.: US 2006/0131453 A1
(43) Pub. Date: Jun. 22, 2006

(54) Method and an apparatus for monitoring the amount of erosion in the waring parts of a crusher

(76) Inventors: Paulo Barscevicius, Sorocaba (BR); Osmair Nunes Alves, Sorocaba (BR); Alfredo Maia Reggio, Sao Paulo (BR); Kimmo Kalevi Vesamaki, Kangasala (FI); Juha Tapio Potila, Pirkkala (FI); Esa Pekka Satola, Espoo (FI)

Correspondence Address: OLIFF & BERRIDGE, PLC, P.O. BOX 19928, ALEXANDRIA, VA, 22320, US

(21) Appl. No.: 10/519,619

(22) PCT Filed: Jul. 2, 2003
(86) PCT No.: PCT/FI03/00534

§ 371 Date: Nov. 25, 2005

(30) Foreign Application Priority Data
Jul. 5, 2002 (FI) 20021326

(51) Int. Cl. B02C 25/00

(52) U.S. Cl. 241/36

(57) ABSTRACT

A method and apparatus are disclosed for monitoring the amount of erosion in the wearing parts of a crusher, in which method the wearing of the crusher is provided with a wear sensor that issues a signal to the crusher's automatic control system as erosion in the wearing part reaches a predetermined depth. Upon receiving the signal, the control system initiates predetermined actions, such as an alarm, stopping the crusher and/or ordering of a spare part. Information on the amount of erosion in a wearing part is transmitted wirelessly to the automatic control system.

The invention relates to the monitoring of the amount of erosion in the wearing parts of crushers. More specifically, the invention relates to crushers equipped with an automatic control system.

Wear monitoring of the wearing parts in a crusher is vital to avoid “wear-through” of a wearing part resulting in a considerably expensive and time-consuming repair of the crusher as compared with a normal replacement of the crusher's wearing part.

In patent publication U.S. Pat. No. 6,129,297 is disclosed one method of monitoring the progress of wear in the wearing parts of a crusher. According to this invention, on the rear surfaces of the wearing parts in the crusher are made recesses reaching up to a depth that represents the maximum allowable degree of wear of the wearing parts in the crusher. The recesses are filled with a suitable material such as a color composition. When the erosion of the wearing parts eventually reaches a point that reveals the recesses, the color composition spreads onto the surfaces of the wearing parts of the crusher, wherefrom the wear indication is easy to detect by the crusher operator. However, this kind of arrangement fails to provide on-line wear information during crushing inasmuch as the crusher must always be stopped for inspection thus causing losses in production capacity. Moreover, the amount of erosion can be monitored only by climbing onto the crusher, a task that invariably involves a risk of operator safety.

The present invention is based on equipping the wearing parts of a crusher with wear sensors that at the instant of the wearing parts reaching a given degree of wear deliver a signal to the crusher's automatic control system. Based on this signal, the automatic control system issues an alarm and/or stops the crusher. The control system may optionally be complemented with an automatic ordering system of wearing parts, whereby setting the wear sensor to alarm at a predetermined wear threshold, the automatic control system may launch a spare part order in order to have the spare part available on-site when monitored wear parts of the crusher reach the end point of their service life requiring a replacement part.

More specifically, the method according to the invention is characterized by what is stated in the characterizing part of claim 1, and the apparatus according to the invention is characterized by what is stated in the characterizing part of claim 5.

In the following, the invention will be examined in more detail by making reference to the appended drawing in which

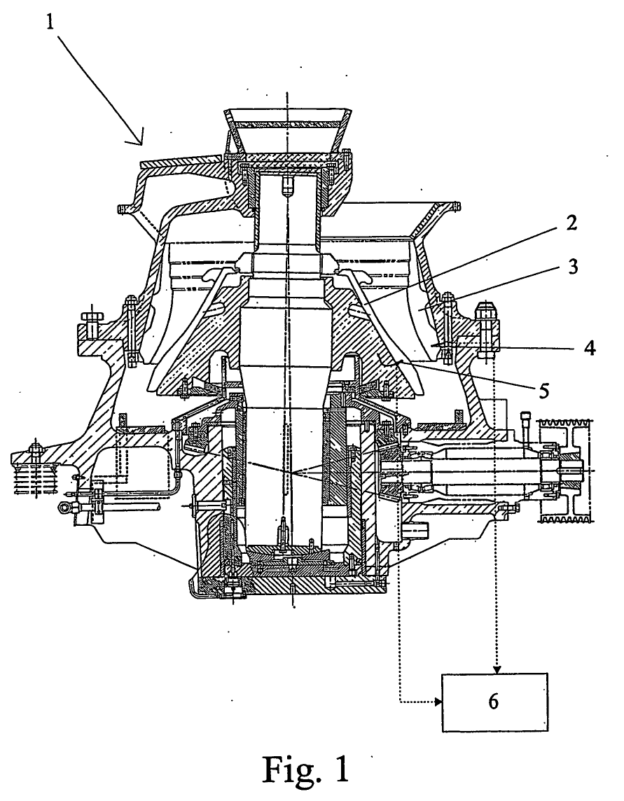

FIG. 1 shows a crusher control system according to the invention.

Referring to FIG. 1, therein is shown the adaptation of an apparatus according to the invention to the construction of a gyratory crusher 1. The wearing parts of the gyratory crusher, namely an inner liner 2 and an outer liner 3, are equipped with wear sensors 4, 5. The functions of the crusher are steered by an automatic control system 6 of the crusher.

In the illustrated exemplary embodiment, the wear sensors are embedded at predetermined depths in the crusher liners. As the amount of erosion reaches the level of the sensors, the sensors either start to transmit a signal to the crusher's automatic control system that then performs certain preprogrammed functions or, alternatively, cease to send a signal, whereupon the control system after the lapse of a predetermined delay performs the preprogrammed functions.

Upon receiving an alarm signal from the sensors, the automatic control system may either forward the alarm to the crusher operator or alternatively automatically stop the crusher. In its simplest form, the control system issues the alarm as a visual or acoustic signal. The control system may optionally be complemented with automatic routines of spare part ordering, whereby the control system upon the receipt of the wear threshold signal issues the spare part order. To this end, the wear sensors must be embedded at a correct depth in the wearing parts such that the crusher operation can be continued using the old wearing part during the delivery time of the new wearing part.

In its simplest form, the sensor embedded in the wearing part may comprise a conductor loop surrounded by an insulating material. Hereby, an alarm is issued at the instant the loop is interrupted due to wear. Alternatively, the system may be equipped with other kinds of simple on-off type switches or sensors.

The signal issued by a sensor embedded in a given wearing part may also be transmitted wirelessly to the exterior side of the crusher by means of a separate transmitter connected to the sensor. Respectively, the crusher's automatic control system must be equipped with a compatible receiver. By complementing the wear sensor with an integral power supply, the compact sensor package can be either embedded entirely in a wearing part of the crusher or, alternatively, adapted between the wearing part and the surface supporting the same, whereby all complications due to sensor wiring are avoided.

In the former case, the operating energy of the sensor can be delivered, for example, by a battery. The integrated sensor package may also be provided with a piezoelectric device capable of generating electrical energy. One useful type of self-contained energy source is a mechanical converter of kinetic-to-electrical energy such as is used in wristwatches, for instance. One further alternative way of generating the operating power of the sensor is energy capture by means of RF techniques from an electromagnetic field surrounding the crusher.

In the prior art it has been conventional to use the crusher's control system also for controlling both the material infeed machinery and the crushed material discharge machinery. Now, the wear sensors can be configured to control the entire machinery system in such a fashion that, e.g., at an alarm issued by a wear sensor, material infeed into the crusher is stopped.

The invention may also be implemented by way of utilizing a plurality of separate wear sensors connected to the crusher control system so that different kinds of actions are initiated depending on the sensor of the system issuing an alarm. In this fashion, e.g., an amount of erosion reaching a predetermined depth first triggers a warning alarm of exhausting wearing parts to the crusher operator. If the crusher operator fails to respond to the warning and allows the amount of erosion to progress down to a second depth level, the control system may be allocated to stop the crusher thus preventing operator negligence from causing damage to the crusher.

The invention is not limited to any given type of crusher, but instead may be adapted to all kinds of crushers equipped with wearing parts.

Further, the invention is not limited to the wear sensors of a given type, but instead may utilize any type of sensor capable of monitoring the amount of erosion in the wearing parts of crushers.

1. A method for monitoring the amount of erosion in the wearing parts of a crusher, in which method the erosion of the wearing parts of a crusher is monitored by the crusher's automatic control system and, as erosion in the wearing parts reaches a predetermined depth, the control system initiates predetermined actions, which actions comprise issuing an alarm, characterized in that information on the amount of erosion in a wearing part of the crusher is transmitted wirelessly to the automatic control system of the crusher and that the predetermined actions further comprise at least one of the following actions: stopping the crusher or stopping material infeed to the crusher or ordering a wearing part for the crusher.

2. The method of claim 1, characterized in that the predetermined depth of erosion of the wearing parts is such that the crusher operation can be continued using the old wearing part during the delivery time of the new wearing part.

3. The method of claim 1, characterized in that a plurality of separate wear sensors connected to the crusher control system is utilized so that different kind of actions are initiated depending on the sensor of the system issuing an alarm.

4. An apparatus for monitoring the amount of erosion in the wearing parts of a crusher, the apparatus comprising an automatic control system of the crusher, and at least one wear sensor mounted on the wearing part of the crusher, characterized in that said wear sensor is equipped with means for transmitting the measurement signal wirelessly to the automatic control system of the crusher and with a self-contained energy source.

5. The apparatus of claim 4, characterized in that the self-contained energy source comprises means for converting kinetic energy into electrical energy.

6. The apparatus of claim 4, characterized in that the self-contained energy source comprises a piezoelectric device for generating electrical energy.

7. The apparatus of claim 4, characterized in that the self-contained energy source comprises means for capturing electrical energy from an electromagnetic field launched about the crusher.

8. The apparatus of claim 4, characterized in that the wear sensor comprises a conductor embedded in an insulator.

9. The apparatus of claim 5, characterized in that the wear sensor comprises a conductor embedded in an insulator.

10. The method of claim 2, characterized in that a plurality of separate wear sensors connected to the crusher control system is utilized so that different kind of actions are initiated depending on the sensor of the system issuing an alarm.

11. The apparatus of claim 5, characterized in that the wear sensor comprises a conductor embedded in an insulator.

12. The apparatus of claim 6, characterized in that the wear sensor comprises a conductor embedded in an insulator.

13. The apparatus of claim 7, characterized in that the wear sensor comprises a conductor embedded in an insulator.

14. The apparatus of claim 6, characterized in that the wear sensor comprises a conductor embedded in an insulator.

15. The apparatus of claim 7, characterized in that the wear sensor comprises a conductor embedded in an insulator.

16. The apparatus of claim 8, characterized in that the wear sensor comprises a conductor embedded in an insulator.
